(19) United States
(12) Patent Application Publication
(10) Pub. No.: US 2026/0332649 A1
(43) Pub. Date: Oct. 22, 2026

(54) METHODS FOR PROVING AND VERIFYING THE USE OF A CIPHER SUITE, AND ASSOCIATED VERIFICATION ENTITY, COMMUNICATION DEVICES, TERMINAL AND COMPUTER PROGRAM

(71) Applicant: Orange, Issy-les-Moulineaux (FR)

(72) Inventors: Romuald Corbel, Chatillon (FR); Emile Stephan, Chatillon (FR)

(21) Appl. No.: 19/116,898

(22) PCT Filed: Sep. 25, 2023
(86) PCT No.: PCT/EP2023/076320

§ 371 Date: Mar. 28, 2025

(30) Foreign Application Priority Data
Sep. 29, 2022 (FR) 2209940

(51) Int. Cl. H04L 9/32; H04L 9/16; H04L 9/40

(52) U.S. Cl. CPC H04L 63/205; H04L 63/04; H04L 63/166

(57) ABSTRACT

Methods and devices for proving and verifying the use of a cipher suite are provided. A method for verifying the use of a cipher suite for encrypting data exchanged between a first device and a second device is implemented by a verification entity and includes sending a challenge to the first device, receiving a cipher key and an encrypted challenge by the second device, and verifying the use of the suite using the sent challenge, the received encrypted challenge, the key and the suite.

### TECHNICAL FIELD

The present invention relates to the general field of telecommunications, and more particularly to the fields of computer networks and information security. Particularly, the present invention concerns methods for proving and verifying the usage of a cipher suite, as well as a verification entity, communication devices, a terminal, a computer program and an information medium associated thereto. The present invention finds a particularly advantageous application, although without limitation, for the implementation of devices for orchestrating computer systems, applications and services or API (Application Programming Interface) orchestrator.

### PRIOR ART

The invention particularly lies in the context of the encryption of communications between two communication devices in a network.

To secure communications between two communication devices, it is known to use a set of algorithms referred to as a “cipher suite”. Typically, the set of algorithms in a cipher suite comprises: a key exchange algorithm; a global encryption algorithm; and a message authentication algorithm.

There are currently in the state of the art a multitude of cipher suites that can be used to encrypt communications. However, some cipher suites are obsolete and do not guarantee a satisfactory level of security for encrypting communications. It is therefore essential to be able to verify that two communication devices are not exploiting an obsolete cipher suite to encrypt their communications.

However, it appears very complex for a third party entity, for example for a security control entity, to verify whether the data exchanged between two communication devices on a network are actually secure. Let us take as example the TLS (Transport Layer Security) protocol for securing the exchanges over a computer network. So, within the framework of this protocol, reading the messages during the establishment of a connection between two communication devices allows to identify the type of cipher suite announced for the connection. However, this reading alone is insufficient since it does not allow in particular proving that the cipher suite possibly used is indeed the one identified, and even if the identification is correct, whether the identified suite is actually used by the communication devices during this network connection.

There is therefore a need for a solution to determine and prove the usage of a cipher suite in order to encrypt data exchanged between two communication devices.

### SUMMARY OF THE INVENTION

The present invention aims to overcome all or part of the drawbacks of the prior art, in particular those set out above.

According to one aspect of the invention, there is proposed a method for verifying the usage of a cipher suite to encrypt data exchanged between a first device and a second device in a communication network, the method being implemented by a verification entity and comprising:
sending, to the first device, a challenge;
receiving, from the first or the second device, an encryption key;
receiving, from the first or the second device, a challenge encrypted by the second device; and
verifying a usage of the cipher suite by using at least the sent challenge, the received encrypted challenge, the encryption key, and the cipher suite.

Within the meaning of the invention, a cipher suite designates one or more algorithms used by communication devices to encrypt and/or decrypt exchanged data. As an indication, a cipher suite may comprise: a key exchange algorithm (e.g. Diffie-Helman); an encryption algorithm (e.g. AES); and a message authentication algorithm (e.g. HMAC). It should be noted that a cipher suite is notably defined by an identifier, such as a string of characters describing the algorithm(s) of this suite.

Particularly, the verification entity verifies the usage of the cipher suite by verifying that the received encrypted challenge corresponds to the sent encrypted challenge by using the encryption key and the cipher suite.

Generally, the proposed method allows to determine and prove the usage of a cipher suite to encrypt data exchanged between two communication devices.

More particularly, the proposed method allows the verification entity to verify the usage of the cipher suite to encrypt data exchanged between the first and second devices and, correlatively, allows the first and second devices to provide proof of usage of the cipher suite.

In one particular context of application to the TLS or QUIC protocols, the proposed solution allows a verification entity to verify the usage of a cipher suite by communication devices during a connection (i.e. a communication session) between them. Thus, and more generally, the proposed solution allows a third-party entity (e.g. a network operator, a network application orchestrator, etc.) to control the security of the exchanges between communication devices (e.g. a user and an application server) during a connection.

According to one embodiment, the verification entity obtains an identifier of the cipher suite in at least one message sent by the first or the second device.

This embodiment allows the verification entity to obtain the identifier of the cipher suite, then to verify the usage of this cipher suite by the first and second devices.

In this way, it is not necessary for the verification entity to already have the identifier of the cipher suite used by the first and second devices. This embodiment thus does not require pre-configuration of the verification entity.

According to one embodiment, the verification entity obtains the identifier of the cipher suite in at least one message exchanged between the first and the second device during the establishment of a connection, said at least one exchanged message indicating the use of said cipher suite.

This embodiment allows to identify the announced (i.e. negotiated) cipher suite, during the establishment of a connection between communication devices, in order to secure the exchanges during a connection.

As an indication, the verification entity obtains, according to one embodiment, said at least one message exchanged during the establishment of a connection by using a network probe, the network probe capturing this message on the communication network and relaying it to the verification entity.

According to one embodiment, the verification entity obtains the encryption key and/or the cipher suite in a message sent by the first or the second device to the verification entity. For example, according to one embodiment, the first device sends, to the verification entity, a message (hereinafter referred to as encryption proof) comprising: the challenge encrypted by the second device; the encryption key; and the identifier of the cipher suite.

However, within the framework of the invention, other embodiments could be envisaged according to which the encryption key and/or the cipher suite are predetermined, such that the verification entity has them beforehand.

According to one embodiment, the verification entity implements:
obtaining at least one encrypted message exchanged between the first and the second device;
decrypting said at least one encrypted message obtained by using the encryption key and the cipher suite; and
verifying an integrity of said at least one decrypted message by using at least one message authentication code associated with said at least one decrypted message.

For information purposes, the verification entity obtains, according to one embodiment, said at least one encrypted message by using a network probe, the network probe capturing said at least one encrypted message on the communication network and relaying it to the verification entity.

This embodiment is particularly advantageous in that it allows to prove that communication devices actually use a cipher suite to encrypt the exchanged data.

Particularly, this embodiment allows the verification entity to verify that the first and second devices use the cipher suite in order to encrypt exchanged data.

It is important to emphasize that, within the framework of the invention, the verification entity can verify the usage of the cipher suite: either during the establishment of the connection between the first and second devices; or during communications (i.e. once the connection has been established) between the first and second devices; or both. Thus, the proposed solution allows to provide proof of usage of a cipher suite by communication devices regardless of the time of the connection.

Thus, by regularly implementing the proposed solution, it is possible for a third-party entity to verify over time that communication devices actually use the cipher suite.

According to one embodiment, the verification entity implements:
obtaining at least one encrypted message exchanged between the first and the second device, said at least one encrypted message comprising:
   applicative data encrypted by using another encryption key, distinct from the encryption key received by the verification entity; and
   padding data encrypted by using the received encryption key, said padding data comprising the challenge sent to the first device;
decrypting said encrypted padding data by using the received encryption key and said cipher suite; and
verifying a correspondence between the challenge comprised in said decrypted padding data and the challenge sent to the first device.

This embodiment allows the verification entity to verify that the cipher suite is used to encrypt the messages exchanged between the first and second devices, while preserving the confidentiality of the applicative data communicated between these devices.

The confidentiality of the applicative data is preserved by the use of: a first key, known to the verification entity, to encrypt the padding data comprising the challenge; and a second key, distinct from the first one and unknown to the verification entity, to encrypt the applicative data. Thus, according to this embodiment, the verification entity is able to verify the usage of the cipher suite by using the encrypted challenge comprised in the padding data and cannot however decrypt the applicative data.

More generally, this embodiment allows communication devices to provide proof that they use a cipher suite to encrypt their exchanges without compromising the confidentiality of the exchanged applicative data.

According to this embodiment, the verification entity obtains only messages exchanged between the first and the second device comprising an active unencrypted indicator.

More specifically, the messages exchanged between the first and the second device comprise an unencrypted indicator, either active (e.g. equal to 1) or non-active (e.g. equal to 0), the use of the unencrypted indicator in the exchanged messages being in particular triggered by the receipt of the challenge from the verification entity.

This embodiment allows to mark the messages to be processed by the verification entity to verify the usage of the cipher suite. In other words, the communication devices mark with an unencrypted indicator the messages allowing the verification entity to verify the usage of the cipher suite.

For example, in combination with the preceding embodiment, the first and second devices can mark, with an active unencrypted indicator, the messages comprising an encrypted challenge in the padding data and that must be captured and relayed to the verification entity by the network probe. In this way, the verification entity obtains and processes only the messages allowing to verify the usage of the cipher suite.

Thus, this embodiment allows to verify the usage of the cipher suite by the first and second communication devices while limiting the number of messages to be processed by the verification entity.

According to one embodiment, the unencrypted indicator is comprised in the header of the messages (i.e. packets) exchanged between the first and the second device.

Particularly, according to one embodiment, the QUIC protocol is used to exchange data between the first and the second device and the unencrypted indicator is a bit, called spin bit, comprised in the header of the messages (i.e. packets) exchanged between the first and the second device.

It is recalled that the spin bit of the QUIC protocol is commonly used to measure the communication latency between two communication devices. However, according to the embodiment described here, the spin bit is used to mark the messages to be processed by the verification entity.

This embodiment is in particular advantageous in that it allows, by diverting the usual function of the spin bit, to mark the messages to be captured by a network probe and relayed to the verification entity in order to verify the usage of the cipher suite, without having to include an additional marker in the exchanged messages.

According to one embodiment, the verification entity verifies that the identifier of said cipher suite belongs to a list (e.g. white list) of identifiers of cipher suites considered valid.

Also, the verification entity could, according to one embodiment, verify that the identifier of the cipher suite does not belong to a list (e.g. black list) of identifiers of cipher suites considered invalid (e.g. obsolete, non-secure, etc.).

This embodiment allows to verify that a cipher suite used by communication devices complies with defined security rules.

Thus, this embodiment allows a third-party entity (e.g. a network operator, a network application orchestrator) to control the security of the exchanges between communication devices during a connection.

According to one embodiment, if at least one result of a said verification is negative, the verification entity sends an instruction to interrupt the exchanges between the first and the second device. As an indication, the interruption instruction can in particular be sent to a network control entity (i.e. a network function), and/or to the first device, and/or to the second device.

This embodiment allows to interrupt the communications between the first and the second device, if the proof of usage of the cipher suite provided by the devices is invalid (i.e. the result of the usage verification is negative) or if the cipher suite used is obsolete. This is thus to avoid compromising the security of the exchanges between the communication devices.

According to another aspect of the invention, there is proposed a method for proving the usage of a cipher suite to encrypt data exchanged between a first device and a second device in a communication network, the method being implemented by the first device and comprising:
receiving, from a verification entity, a challenge;
sending, to the second device, the challenge;
receiving, from the second device, the challenge encrypted by the second device by using an encryption key and said cipher suite; and
sending, to the verification entity, the encrypted challenge.

According to another aspect of the invention, there is provided a method for proving the usage of a cipher suite to encrypt data exchanged between a first device and a second device in a communication network, the method being implemented by the second device and comprising:
receiving, from the first device, a challenge;
encrypting the challenge by using an encryption key and said cipher suite; and
sending, to the first device or to a verification entity, the encrypted challenge.

According to one embodiment, at least one of said first and second devices sends, to the verification entity, an encryption proof comprising: the encrypted challenge; the encryption key; and an identifier of the cipher suite.

Within the framework of the invention, other embodiments could also be envisaged according to which the encrypted challenge, the encryption key and the identifier of the cipher suite are sent to the verification entity by the first device and/or the second device in one or more messages.

According to one embodiment, one of the first and second devices sends to the other device, at least one message during an establishment of a connection between the first and second devices, said at least one exchanged message comprising an identifier of the cipher suite to be used.

According to one embodiment, at least one of said first and second devices encrypts at least one message by using the encryption key and the cipher suite and sends said at least one encrypted message.

According to one embodiment, at least one of said first and second devices encrypts at least one message and obtains a message authentication code associated with said at least one message.

According to one embodiment, at least one of said first and second devices encrypts at least one message comprising applicative data and padding data, the applicative data being encrypted by using another encryption key distinct from the encryption key sent to the verification entity, the padding data comprising the challenge received from the verification entity and being encrypted by using the encryption key sent to the verification entity.

According to one embodiment, at least one of said first and second devices marks with an unencrypted indicator the messages sent that must be obtained and processed by the verification entity to verify the usage of the cipher suite.

According to one embodiment, at least one of said first and second devices receives at least one encrypted message and decrypts said at least one encrypted message by using the encryption key and the cipher suite.

According to one embodiment, a TLS type protocol is used to exchange data between the first and the second device. More specifically, according to one embodiment, the TLS, DTLS, OSCORE, EDHOC or QUIC protocol is used to exchange data between the first and the second device.

According to one embodiment, the QUIC protocol is used to exchange data between the first and the second device.

According to another aspect of the invention, there is provided an entity for verifying the usage of a cipher suite to encrypt data exchanged between a first device and a second device in a communication network, the verification entity comprising:
a sending module configured to send, to the first device, a challenge;
a receiving module configured to receive, from the first or the second device, an encryption key and to receive, from the first or the second device, a challenge encrypted by the second device; and
a verification module configured to verify a usage of said cipher suite by using at least the sent challenge, the received encrypted challenge, the encryption key, and said cipher suite.

According to another aspect of the invention, there is provided a communication device, called first device, comprising:
a first receiving module configured to receive, from a verification entity, a challenge;
a first sending module configured to send, to the second device, the challenge;
a second receiving module configured to receive, from the second device, the challenge encrypted by the second device by using an encryption key and a cipher suite; and
a second sending module configured to send, to the verification entity, the encrypted challenge.

According to another aspect of the invention, there is provided a communication device, called second device, comprising:
a receiving module configured to receive, from the first device, a challenge;
an encryption module configured to encrypt the challenge by using an encryption key and a cipher suite; and
a sending module configured to send, to the first device or to a verification entity, the encrypted challenge.

According to another aspect of the invention, there is provided a terminal comprising a verification entity in accordance with the invention or a communication device in accordance with the invention.

According to one aspect of the invention, there is provided a computer program comprising instructions for the implementation of the steps of a method in accordance with the invention, when the computer program is executed by at least one processor or one computer.

The computer program may be formed of one or more sub-parts stored in the same memory or in separate memories. The program may use any programming language, and be in the form of source code, object code or intermediate code between source code and object code, such as in a partially compiled form, or in any other desirable form.

According to one aspect of the invention, there is provided a computer-readable information medium comprising a computer program in accordance with the invention.

The information medium may be any entity or device capable of storing the program. For example, the medium may include a storage means, such as a non-volatile memory or ROM, for example a CD-ROM or a microelectronic circuit ROM, or a magnetic recording means, for example a floppy disk or a hard disk. On the other hand, the storage medium may be a transmissible medium such as an electrical or optical signal, which may be conveyed via an electrical or optical cable, by radio or by a telecommunications network or by a computer network or by other means. The program according to the invention may particularly be downloaded over a computer network. Alternatively, the information medium may be an integrated circuit into which the program is incorporated, the circuit being adapted to execute or to be used in the execution of the method in question.

The proposed usage proof methods, verification entity, communication devices, terminal, program, and medium have the advantages described above in relation to the proposed usage verification method.

### BRIEF DESCRIPTION OF THE DRAWINGS

Other characteristics and advantages of the present invention will emerge from the description provided below, illustrating embodiments of the invention given as examples and without any limitation, with reference to the attached drawings:

FIG. 1 represents, in the form of a flowchart, steps of methods for proving and verifying the usage of a cipher suite according to one embodiment of the invention;

FIG. 2 represents, in the form of a flowchart, steps of methods for proving and verifying the usage of a cipher suite according to one embodiment of the invention;

FIG. 3A, FIG. 3B and FIG. 3C represent examples of messages processed and exchanged by the communication devices according to embodiments of the invention;

FIG. 4 represents one example of software and hardware architectures of a verification entity and communication devices according to one embodiment of the invention; and

FIG. 5 represents one example of functional architectures of a verification entity and communication devices according to one embodiment of the invention.

### DESCRIPTION OF THE EMBODIMENTS

The proposed solution in particular takes place in a context in which a communication device CLT (called first device) and a communication device SRV (called second device) exchange data (i.e. messages) in an encrypted manner via a communication network NET. To do this, the devices CLT and SRV encrypt the exchanged data by using a cipher suite CIPHER, i.e. the set of algorithms that allow securing the exchanges.

In this context, it is particularly a question of allowing a verification entity CSC to determine and prove the usage of the suite CIPHER in order to encrypt and decrypt data exchanged between the devices CLT and SRV.

No limitation is attached to the encryption mechanism used to encrypt the data exchanged between the communication devices CLT and SRV. For example, the devices CLT and SRV use, according to one embodiment, a symmetric encryption mechanism to encrypt exchanged data.

There is also no assumption as to the nature of the verification entity CSC and of the communication devices CLT and SRV. They may consist of terminal equipment used by the clients of a network operator such as, for example, a set top box (STB), a user equipment (UE), a personal computer (PC), a Smartphone, a connected television or a tablet, but also by equipment managed by a computer operator or an operator of a telecommunications network (for example, server, firewall, router), this equipment being able to be fixed or mobile. The communication devices may also be software applications, or service instances hosted in equipment.

As an indication, at least one element among the verification entity CSC and the devices CLT and SRV is, according to one embodiment, implemented by (or comprised in) a terminal, such as a mobile telephone, for example a Smartphone, or a tablet, or a computer.

Furthermore, no limitation is attached to the nature of the communication network NET, which may be a mobile telephone network (2G, 3G, 4G, 5G, 6G, etc.), a computer network of the Internet type, or any other network (proprietary, etc.) that may be envisaged.

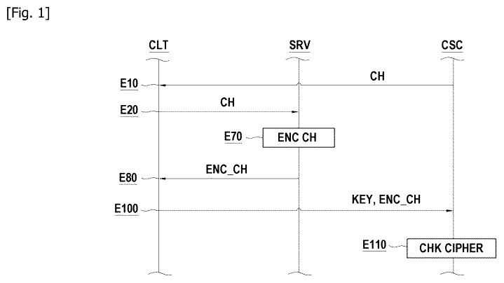

FIG. 1 represents, in the form of a flowchart, steps of methods for proving and verifying the usage of a cipher suite to encrypt data exchanged between a first and a second communication device according to one embodiment of the invention.

As illustrated in FIG. 1, and according to one embodiment of the invention, the proposed methods for proving and verifying the usage of a cipher suite comprise at least one of the steps E10 to E110 described below.

In step E10, the verification entity CSC sends, to the device CLT, a challenge CH. For example, the challenge CH is a string of characters.

In step E20, the device CLT sends, to the device SRV, the received challenge CH.

In step E70, the device SRV encrypts the challenge CH by using a cipher suite CIPHER and an encryption key KEY, and thus obtains an encrypted challenge ENC_CH.

In step E80, the device SRV sends, to the device CLT, the encrypted challenge ENC_CH.

In step E100, the device CLT sends, to the verification entity CSC, the key KEY and the encrypted challenge ENC_CH.

In step E110, the verification entity CSC verifies the usage of the suite CIPHER by using the challenge CH, the encrypted challenge ENC_CH, the key KEY and the suite CIPHER.

According to one embodiment, the verification entity CSC in step E110 verifies that the encrypted challenge ENC_CH corresponds to the encrypted challenge CH by using the key KEY and the suite CIPHER.

For example, the verification entity CSC decrypts the encrypted challenge ENC_CH and then compares the decrypted challenge obtained with the challenge CH sent. If the decrypted challenge obtained is identical to the challenge CH sent, then the suite CIPHER has actually been used by the device SRV to encrypt the challenge CH; otherwise, the result of the verification is negative and the usage of the suite CIPHER has not been proven.

Thus, the proposed solution described here allows the verification entity CSC to verify that the device SRV uses the suite CIPHER to encrypt the challenge CH and, correlatively, allows this device SRV to provide proof of usage of the suite CIPHER.

More generally, and as described below, the proposed solution allows the verification entity CSC to verify the usage of the suite CIPHER to encrypt the data exchanged between the devices CLT and SRV and, correlatively, allows the devices CLT and SRV to provide proof of usage of the suite CIPHER.

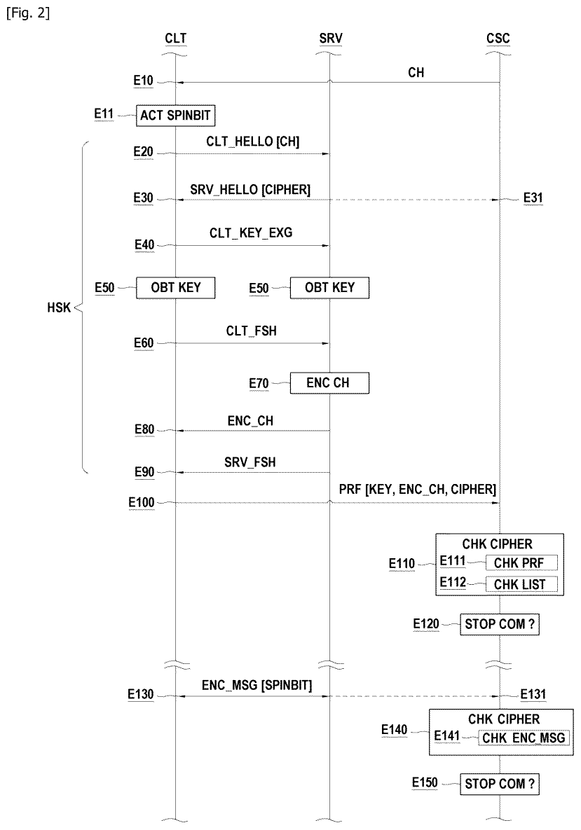

FIG. 2 represents, in the form of a flowchart, steps of methods for proving and verifying the usage of a cipher suite according to one embodiment of the invention.

Examples of application to the TLS or QUIC protocol: FIG. 2 illustrates, by way of example, one embodiment of the invention in one particular application context according to which one of the TLS, DTLS, OSCORE, EDHOC or QUIC protocols is used to exchange data between the devices CLT and SRV. The exemplary embodiment provided below repeats, as such, the steps described with reference to FIG. 1 in this particular application context.

According to this example, the device CLT (e.g. the client of the TLS/QUIC protocol) initiates and establishes a connection (or a communication session) with the device SRV (e.g. the server of the TLS/QUIC protocol), to exchange data securely.

The acronym TLS will refer here to at least one of the following versions of the “Transport Layer Security” protocol: TLS 1.0 as defined by RFC 2246 in January 1999; TLS 1.1 as defined by RFC 4346 in April 2006; TLS 1.2 as defined by RFC 5246 in August 2008; or TLS 1.3 as defined by RFC 8446 in August 2018.

The acronym DTLS will refer here to at least one of the following versions of the “Datagram Transport Layer Security” protocol: DTLS 1.2 as defined by RFC 6347; or DTLS 1.3 as defined by RFC 9147.

The acronym OSCORE will refer here to the “Object Security for Constrained RESTful Environments” protocol as defined by RFC 8613.

The acronym EDHOC will refer here to the protocol, used in particular for Internet of Things terminals, “Ephemeral Diffie-Hellman Over COSE” as defined in document “draft-ietf-lake-edhoc-15” published by the “Internet Engineering Task Force” and accessible at the following link: https://datatracker.ietf. org/doc/draft-ietf-lake-edhoc/.

And the term QUIC refers to at least one of the versions of the QUIC transport protocol as defined by: RFC 8999 in May 2021; RFC 9000 in May 2021; RFC 9001 in May 2021; RFC 9002 in May 2021; RFC 9221 in March 2022.

Establishment of a connection between the devices CLT and SRV: as illustrated in FIG. 2, and according to one embodiment of the invention, the proposed methods for proving and verifying the usage of a cipher suite comprise at least one of the steps E10 to E120 described below.

In step E10, the verification entity CSC sends a challenge CH to the device CLT.

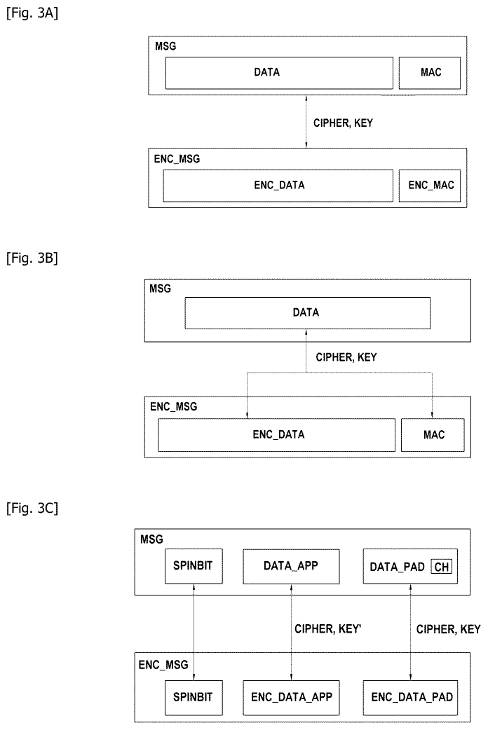

In step E11, according to one particular embodiment, the device CLT activates the use of a unencrypted indicator SPINBIT for the messages exchanged with the device SRV, this activation being triggered by the receipt of the challenge CH in step E10. The use of this indicator SPINBIT is described in more detail below with reference to FIG. 3B.

In step E20, the device CLT sends, to the device SRV, a message CLT_HELLO to initiate a connection with it. The message CLT_HELLO comprises the challenge CH, received from the verification entity CSC. Furthermore, the message CLT_HELLO comprises, according to one embodiment: the identifier(s) of the cipher suites that can be used by the device CLT; and a string of random bytes (called client random).

In step E30, the device SRV sends, to the device CLT, a message SRV_HELLO in response to the message CLT_HELLO. More particularly, the message SRV_HELLO comprises, according to one embodiment: an identifier of the cipher suite CIPHER chosen by the device SRV for the connection; and another random string of bytes (called server random). According to one particular embodiment, the message SRV_HELLO further comprises a parameter for obtaining an encryption key, used for example by the Diffie-Helman key exchange algorithm to obtain an encryption key.

It should be noted that the message SRV_HELLO thus indicates to use the suite CIPHER in order to encrypt and decrypt the data exchanged between the devices CLT and SRV during the connection.

More specifically, a suite CIPHER is defined by an identifier describing the algorithms of the suite. One example of identifier of a cipher suite is the following:
TLS_DH_RSA_WITH_AES_256_GCM_SHA384. The meaning of this identifier is as follows: TLS defines the protocol for which this cipher suite is intended; DH indicates the key exchange algorithm used; RSA is the authentication mechanism used during the establishment of the connection; AES is the cipher used during the connection; 256 (bits) is the size of the encryption key; GCM is the encryption type; SHA is the hash function used for the message authentication mechanism; and 384 (bits) is the size of the digest used to sign the messages.

In step E31, according to one particular embodiment, the verification entity CSC obtains the message SRV_HELLO. The verification entity CSC thus obtains the identifier of the suite CIPHER used by the devices CLT and SRV during the connection. The verification entity CSC obtains, according to one embodiment, the message SRV_HELLO by using a network probe that captures this message on the network NET and relays it to the verification entity CSC.

In step E40, the device CLT sends, to the device SRV, a message CLT_KEY_EXG comprising: according to one embodiment, a premaster secret; or according to another embodiment a key obtaining parameter.

In step E50, the devices CLT and SRV respectively obtain a key KEY for the connection (also called session key). As an example, the devices CLT and SRV use a key exchange and derivation algorithm, such as Diffie-Hellman, to obtain the key KEY from the client random, the server random and the aforementioned key obtaining parameters. According to another example, the devices CLT and SRV obtain the key KEY from the client random, the server random and the premaster secret.

In step E60, the device CLT sends, to the device SRV, an encrypted message CLT_FSH by using the key KEY and the suite CIPHER. According to one embodiment, following receipt of the message CLT_FSH, the device SRV decrypts this message by using the key KEY, then verifies the integrity of the decrypted message. Thus, the device SRV verifies that the device CLT has correctly obtained the same key KEY.

In step E70, the device SRV encrypts the challenge CH, received from the device CLT, by using the key KEY and the suite CIPHER and thus obtains an encrypted challenge ENC_CH.

In step E80, the device SRV sends, to the device CLT, the encrypted challenge ENC_CH.

More particularly, the device SRV adds, according to one embodiment, the encrypted challenge ENC_CH to a message sent to the device CLT and comprising a session ticket.

In step E90, the device SRV sends, to the device CLT, a message SRV_FSH encrypted by using the key KEY and the suite CIPHER. According to one embodiment, following receipt of the message SRV_FSH, the device CLT decrypts this message by using the key KEY, then verifies the integrity of the decrypted message. Thus, the device CLT verifies that the device SRV has correctly obtained the same key KEY.

Within the framework of the invention, one embodiment could also be envisaged according to which steps E80 and E90 are performed concomitantly.

In one embodiment, steps E20 to E90 constitute an establishment of the connection HSK (or handshake) between the devices CLT and SRV.

It is recalled that the invention applies in particular to the TLS, DTLS, OSCORE, EDHOC and QUIC protocols, such that the devices CLT and SRV can establish a connection in accordance with these protocols and, as such, can implement any step necessary for the establishment of the connection.

According to one particular embodiment, the verification entity CSC obtains, in particular by using the network probe, all or part of the messages exchanged between the devices CLT and SRV during the establishment of the connection HSK, for example by using a network probe as described above with reference to step E31.

In step E100, the device CLT sends, to the verification entity CSC, an encryption proof PRF comprising: the encryption key KEY; the encrypted challenge ENC_CH; and the identifier of the suite CIPHER. The encryption proof PRF further comprises, according to one embodiment, the challenge CH. According to one particular embodiment, the verification entity CSC obtains the key KEY and the identifier of the suite CIPHER by receipt of the encryption proof PRF. However, other embodiments of the invention could be envisaged in which the key KEY and/or the suite CIPHER are predetermined or are obtained by the verification entity CSC by using a network probe in one or more messages exchanged between the devices CLT and SRV, for example as described with reference to step E31.

In step E110, the verification entity CSC verifies the usage of the suite CIPHER by using the encryption proof PRF. According to one embodiment, step E110 comprises at least one of steps E111 and E112 described below.

In step E111, the verification entity CSC verifies that the encryption proof PRF is valid. More particularly, the verification entity CSC verifies in step E111 that the encrypted challenge ENC_CH corresponds to the encrypted challenge CH by using the key KEY and the suite CIPHER.

In step E112, the verification entity CSC verifies the validity of the suite CIPHER, in particular by verifying that the identifier of the suite CIPHER belongs to a list of identifiers of cipher suites considered valid (i.e. considered compliant with defined security rules). The verification entity CSC could also, according to one embodiment, verify in step E112 that the identifier of the suite CIPHER does not belong to a list (e.g. blacklist) of identifiers of cipher suites considered invalid (e.g. obsolete, non-secure, etc.). Step E112 thus allows to verify that the suite CIPHER used complies with the defined security rules.

In step E120, if the result of the verification in step E110 is negative, the verification entity CSC sends an instruction to interrupt the exchanges between the devices CLT and SRV. The interruption instruction may in particular be sent to the device CLT, and/or to the device SRV, and/or to a network control entity (i.e. a network function). Step E120 allows to interrupt the communications between the two devices CLT and SRV, if the proof PRF is invalid or if the suite CIPHER is obsolete. Thus, this step advantageously allows not to compromise the security of the communications between the devices CLT and SRV.

The proposed solution as described above allows the verification entity CSC to determine and verify the usage of the suite CIPHER during the connection between the devices CLT and SRV to encrypt exchanged data. Correlatively, the proposed solution allows the devices CLT and SRV to prove to the verification entity CSC that they use the suite CIPHER to encrypt the exchanges during the connection.

More specifically, the proposed solution allows the verification entity CSC to verify that the suite CIPHER announced during the establishment of the connection HSK is actually used by the devices CLT and SRV and that it complies with security rules.

Communications between the devices CLT and SRV: as illustrated in FIG. 2, and according to one embodiment of the invention, the proposed methods for proving and verifying the usage of a cipher suite comprise at least one of the steps E130 to E150 described below. This embodiment can of course be combined with the embodiments previously described.

Following the establishment of the connection between the devices CLT and SRV described above, these communicate in an encrypted manner by using the key KEY and the suite CIPHER.

In step E130, the devices CLT and SRV exchange an encrypted message ENC_MSG.

Particularly, the encrypted message ENC_MSG is obtained by encrypting a message MSG by using at least the key KEY and the suite CIPHER. Obtaining the encrypted message ENC_MSG by one of the devices CLT and SRV from the message MSG is in particular described in more detail below with reference to FIGS. 3A and 3B.

In step E131, the verification entity CSC obtains the encrypted message ENC_MSG, for example by using a network probe capturing the encrypted message ENC_MSG on the network NET and relaying it to the verification entity CSC.

In step E140, the verification entity CSC verifies the usage of the suite CIPHER by using the encrypted message ENC_MSG. According to one embodiment, step E140 comprises a step E141 described below.

In step E141, the verification entity CSC verifies that the suite CIPHER was used to obtain the encrypted message ENC_MSG. Step E141 is in particular described in more detail below with reference to FIGS. 3A and 3B.

In step E150, if the result of the verification in step E140 is negative, the verification entity CSC sends an instruction to interrupt the exchanges between the devices CLT and SRV. The interruption instruction may in particular be sent to the device CLT, and/or to the device SRV, and/or to a network control entity (i.e. a network function). Step E150 allows to interrupt the communications between the two devices CLT and SRV, if the message ENC_MSG is not encrypted with the suite CIPHER. Thus, this step advantageously allows not to compromise the security of the communications between the devices CLT and SRV.

The proposed solution as described above allows the verification entity CSC to verify that the devices CLT and SRV actually use the suite CIPHER to encrypt and decrypt exchanged data.

Usage verification during the establishment of the connection and/or during communications: It is important to emphasize that, within the framework of the invention, the verification entity CSC can verify the usage of the suite CIPHER: either during the establishment of the connection between the devices CLT and TLS (in accordance with the embodiments described with reference to steps E10 to E120); or during communications (i.e. once the connection has been established) between the devices CLT and SRV (in accordance with the embodiments described with reference to steps E130 to E150); or both.

Thus, the proposed solution allows to provide proof of usage of the suite CIPHER by the devices CLT and SRV regardless of the time of the connection.

FIGS. 3A, 3B and 3C represent examples of messages processed and exchanged by the communication devices according to embodiments of the invention.

As previously mentioned, according to one embodiment, the devices CLT and SRV exchange in step E130 one or more encrypted messages ENC_MSG, these messages being captured by a network probe and relayed to the verification entity CSC in step E131. Then, the verification entity CSC verifies in step E141 that the cipher suite CIPHER has been used to obtain the encrypted message(s) ENC_MSG.

Also, three embodiments of steps E130 and E141 are described below with reference to FIGS. 3A, 3B and 3C respectively.

According to a first embodiment illustrated in FIG. 3A, the encrypted message ENC_MSG, exchanged in step E130 between the devices CLT and SRV, is obtained by encryption of a message MSG by using the suite CIPHER and the key KEY.

More specifically, the message MSG comprises: data DATA and a message authentication code MAC. As a result, the encrypted message ENC_MSG comprises: encrypted data ENC_DATA; and an encrypted code ENC_MAC.

The code MAC allows to verify the integrity of the message MSG. For example, the message authentication code MAC is obtained from the data DATA by using a signature algorithm, such as a hash function. This embodiment thus implements an encryption and authentication technique called “mac-then-encrypt”.

During step E141, the verification entity CSC decrypts the encrypted message ENC_MSG by using the key KEY and the suite CIPHER, then verifies the integrity of the decrypted message MSG by using the data DATA and the code MAC.

Thus, this embodiment allows the verification entity CSC to verify that the suite CIPHER is actually used to encrypt messages exchanged between the devices CLT and SRV.

According to a second embodiment illustrated in FIG. 3B, the encrypted message ENC_MSG, exchanged in step E130 between the devices CLT and SRV, is obtained from the message MSG by using the suite CIPHER and the key KEY.

More specifically, the message MSG comprises: data DATA. And, the encrypted message ENC_MSG comprises: encrypted data DATA; and a message authentication code MAC allowing to verify the integrity of the message MSG.

According to this embodiment, the encrypted data ENC_DATA are obtained by encryption of the data DATA by using the suite CIPHER and the key KEY; and the code MAC is obtained by using a hash function from the data DATA and/or associated data. This embodiment allows in particular to implement an encryption and authentication technique called “encrypt-and-mac” and, more particularly, a technique called “Authenticated Encryption with Associated Data”.

During step E141, the verification entity CSC decrypts the encrypted message ENC_MSG (i.e. the encrypted data ENC_DATA) by using the key KEY and the suite CIPHER, then verifies the integrity of the decrypted message MSG by using the data DATA and the code MAC.

This embodiment thus allows the verification entity CSC to verify that the suite CIPHER is actually used to encrypt messages exchanged between the devices CLT and SRV.

According to a third embodiment illustrated in FIG. 3C, the encrypted message ENC_MSG exchanged in step E130 between the devices CLT and SRV comprises: encrypted applicative data ENC_DATA_APP; and encrypted padding data ENC_DATA_PAD.

The encrypted applicative data ENC_DATA_APP are, according to one embodiment, obtained by encrypting applicative data DATA_APP by using the suite CIPHER and an encryption key KEY′ distinct from the aforementioned key KEY.

The encrypted padding data ENC_DATA_PAD are, according to one embodiment, obtained by encrypting padding data DATA_PAD (also called stuffing data, for example random data) by using the suite CIPHER and the key KEY. More particularly, the padding data DATA_PAD comprise the challenge CH.

During step E141, the verification entity CSC decrypts the encrypted padding data ENC_DATA_PAD by using the key KEY and the suite CIPHER, then verifies the correspondence between the challenge CH comprised in the decrypted padding data DATA_PAD and the challenge CH as sent by the verification entity CSC to the device CLT.

Thus, this embodiment allows the verification entity CSC to verify the usage of the suite CIPHER to encrypt messages exchanged between the devices CLT and SRV, while preserving the confidentiality of the applicative data DATA_APP communicated between the devices CLT and SRV.

Of course, the first, second and third embodiments described above can be combined. It could indeed be envisaged that the devices CLT and SRV exchange, over time, one or more messages MSG according to the first embodiment, and/or one or more messages MSG according to the second embodiment, and/or one or more messages MSG according to the third embodiment. In this case, the verification entity CSC verifies, from one or more captured messages, the usage of the suite CIPHER according to the first, second or third embodiment depending on the captured encrypted message(s).

Use of the unencrypted indicator SPINBIT: According to one embodiment illustrated in FIG. 3C, one or more messages exchanged between the devices CLT and SRV comprise an active (e.g. equal to 1) or non-active (e.g. equal to 0) unencrypted indicator SPINBIT. As indicated previously, the use of the indicator SPINBIT is, according to one embodiment, triggered in step E11 by the receipt of the challenge CH in step E10.

Thus, according to one embodiment, the verification entity CSC obtains (e.g. by capture) only messages exchanged between the devices CLT and SRV comprising an active (e.g. equal to 1) unencrypted indicator SPINBIT, then verifies the usage of the suite CIPHER from the message(s) obtained. This embodiment allows to verify the usage of the suite CIPHER while limiting the number of messages to be obtained and processed by the verification entity CSC.

For example, the devices CLT and SRV activate the unencrypted indicator SPINBIT for the messages ENC_MSG comprising the challenge CH in the padding data DATA_PAD. In this way, the verification entity CSC obtains in step E131 these messages ENC_MSG whose indicator SPINBIT is active, then verifies the usage of the suite CIPHER from the message(s) ENC_MSG obtained.

According to another example, the devices CLT and SRV activate the unencrypted indicator SPINBIT for the messages not comprising applicative data (i.e. control message), such as the messages exchanged during the establishment of the connection HSK between the devices CLT and SRV. Thus, the verification entity CSC obtains (e.g. with the network probe) the messages during the establishment of the connection HSK, in particular the message SRV_HELLO in step E31, which allows the verification entity to identify the suite CIPHER used for the connection.

Furthermore, as previously mentioned, the proposed solution applies in particular to the QUIC protocol. Within the framework of this protocol, the unencrypted indicator SPINBIT is, according to one embodiment, the bit called “spin bit” of the QUIC protocol.

It is recalled that the spin bit of the QUIC protocol is an unencrypted bit of the header of the packets QUIC (i.e. messages). The spin bit is commonly used to measure the communication latency between two devices. However, according to the embodiment described here, the spin bit is used to mark the messages that must be captured by a network probe and relayed to the verification entity CSC. As a non-limiting example, the usage of the spin bit to measure the latency can, according to this embodiment, be limited to the messages exchanged during the establishment of the connection HSK.

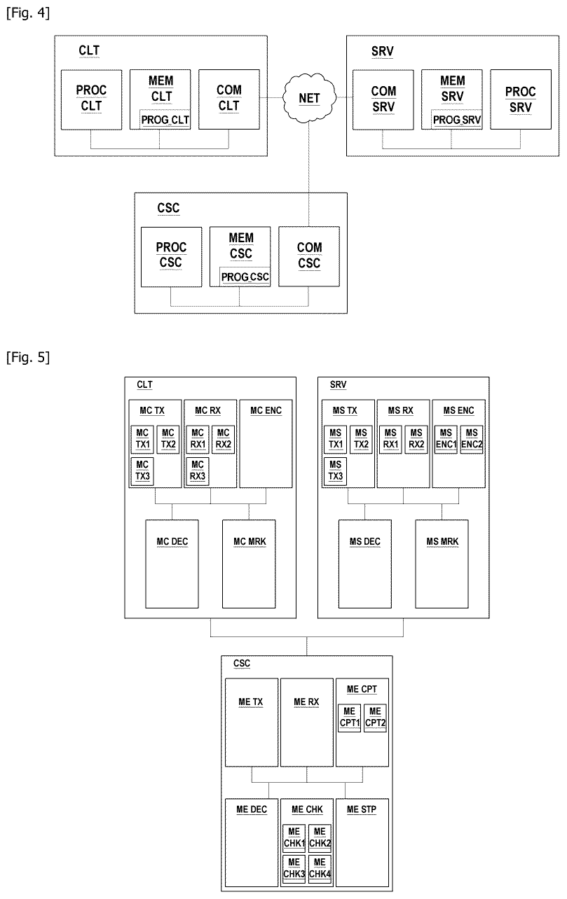

FIG. 4 represents one example of software and hardware architecture of a verification entity and communication devices according to one embodiment of the invention.

As illustrated in FIG. 4, according to one embodiment, the verification entity CSC, the communication devices CLT and SRV are connected via a communication network NET.

The verification entity CSC has, according to one embodiment illustrated in FIG. 4, the hardware architecture of a computer and includes: a processor PROC_CSC, a random access memory, a read-only memory MEM_CSC, and a non-volatile memory. The memory MEM_CSC constitutes an information medium in accordance with the invention, readable by a computer and by the processor PROC_CSC, on which a computer program PROG_CSC in accordance with the invention is recorded. The computer program PROG_CSC includes instructions to perform steps of a method for verifying the usage of a cipher suite in accordance with the invention and implemented by the verification entity CSC, when the computer program PROG_CSC is executed by the processor PROC_CSC.

As illustrated in FIG. 4, the verification entity CSC has, according to one embodiment, a communication module COM_CSC configured to communicate with at least one of the communication devices CLT and SRV via the network NET.

No limitation is attached to the nature of the communication interfaces between the verification entity CSC and the communication devices CLT and SRV, which may be wired or non-wired, and may implement any protocol known to those skilled in the art (Ethernet, Wi-Fi, Bluetooth, 3G, 4G, 5G, 6G, etc.).

The communication device CLT (called first device) has, according to one embodiment illustrated in FIG. 4, the hardware architecture of a computer and includes: a processor PROC_CLT, a random access memory, a read-only memory MEM_CLT and a non-volatile memory. The memory MEM_CLT constitutes an information medium in accordance with the invention, readable by a computer and by the processor PROC_CLT, on which a computer program PROG_CLT in accordance with the invention is recorded. The computer program PROG_CLT includes instructions to perform steps of a method for proving the usage of a cipher suite in accordance with the invention and implemented by the communication device CLT, when the computer program PROG_CLT is executed by the processor PROC_CLT.

As illustrated in FIG. 4, the device CLT has, according to one embodiment, a communication module COM_CLT configured to communicate with the verification entity CSC and/or the communication device SRV.

The communication device SRV (called second device) has, according to one embodiment illustrated in FIG. 4, the hardware architecture of a computer and includes: a processor PROC_SRV, a random access memory, a read-only memory MEM_SRV and a non-volatile memory. The memory MEM_SRV constitutes an information medium in accordance with the invention, readable by a computer and by the processor PROC_SRV, on which a computer program PROG_SRV in accordance with the invention is recorded. The computer program PROG_SRV includes instructions to perform steps of a method for proving the usage of a cipher suite in accordance with the invention and implemented by the communication device SRV, when the computer program PROG_SRV is executed by the processor PROC_SRV.

As illustrated in FIG. 4, the device SRV has, according to one embodiment, a communication module COM_SRV configured to communicate with the verification entity CSC and/or the communication device CLT.

FIG. 5 represents one example of functional architectures of a verification entity and communication devices according to one embodiment of the invention.

In the description below, the modules referenced ME_XX are comprised in the verification entity CSC, the modules referenced MC_XX are comprised in the device CLT, and the modules referenced MS_XX are comprised in the device SRV.

The verification entity CSC comprises, according to one embodiment, modules respectively configured to implement the steps of a method for verifying the usage of a cipher suite in accordance with the invention.

Particularly, the verification entity CSC, according to one embodiment illustrated in FIG. 5, comprises at least one of the following modules:
a sending module ME_TX configured to send a challenge CH to the device CLT;
a receiving module ME_RX configured to receive the encryption proof PRF from the device CLT;
an obtaining module ME_CPT configured to obtain messages exchanged between the devices CLT and SRV, comprising in particular:
   a first obtaining module ME_CPT1 configured to obtain at least one exchanged message SRV_HELLO between the devices CLT and SRV during an establishment of a connection HSK;
   a second obtaining module ME_CPT2 configured to obtain at least one encrypted message ENC_MSG exchanged between the devices CLT and SRV;
a decryption module ME_DEC configured to decrypt at least one encrypted message ENC_MSG obtained by using the key KEY and the suite CIPHER.
a verification module ME_CHK configured to verify the usage of the suite CIPHER by using the challenge CH, the encrypted challenge ENC_CH, the key KEY, and the cipher suite CIPHER, and comprising in particular:
   a first verification module ME_CHK1 configured to verify a correspondence between the encrypted challenge ENC_CH and the encrypted challenge CH by using the key KEY and the suite CIPHER;
   a second verification module ME_CHK2 configured to verify the integrity of at least one decrypted message MSG by using at least one message authentication code;
   a third verification module ME_CHK3 configured to verify a correspondence between a challenge comprised in a decrypted message MSG and the challenge CH;
   a fourth verification module ME_CHK4 configured to verify that the identifier of the suite CIPHER belongs to a list of identifiers of cipher suites considered valid;
a communications interruption module ME_STP configured, if at least one result of a said verification is negative, to send an instruction to interrupt exchanges between the devices CLT and SRV.

The device CLT (called first device) comprises, according to one embodiment, modules respectively configured to implement the steps of a method for proving the usage of a cipher suite in accordance with the invention.

Particularly, the device CLT includes, according to one embodiment illustrated in FIG. 5, at least one of the following modules:
a sending module MC_TX configured to send messages to the device SRV and/or to the verification entity CSC, comprising in particular:
   a first sending module MC_TX1 configured to send the challenge CH to the device SRV;
   a second sending module MC_TX2 configured to send the encryption proof PRF to the verification entity CSC;
   a third sending module MC_TX3 configured to send at least one encrypted message ENC_MSG to the device SRV;
a receiving module MC_RX configured to receive messages from the device SRV and/or from the verification entity CSC, comprising in particular:
   a first receiving module MC_RX1 configured to receive the challenge CH from the verification entity;
   a second receiving module MC_RX2 configured to receive the encrypted challenge ENC_CH from the device SRV; and
   a third receiving module MC_RX3 configured to receive at least one encrypted message ENC_MSG from the device SRV;
an encryption module MC_ENC configured to encrypt at least one message MSG by using the key KEY, the suite CIPHER and, according to one embodiment, the key KEY′;
a decryption module MC_DEC configured to decrypt at least one encrypted message ENC_MSG by using the key KEY, the suite CIPHER and, according to one embodiment, the key KEY′; and
a marking module MC_MRK configured to activate the unencrypted indicator SPINBIT in messages sent to the device SRV.

The device SRV (called second device) comprises, according to one embodiment, modules respectively configured to implement the steps of a method for proving the usage of a cipher suite in accordance with the invention.

Particularly, the device SRV includes, according to one embodiment illustrated in FIG. 5, at least one of the following modules:
a sending module MS_TX configured to send messages to the device CLT, comprising in particular:
   a first sending module MS_TX1 configured to send the encrypted challenge ENC_CH to the device CLT;
   a second sending module MS_TX2 configured to send a message SRV_HELLO to the device CLT during the establishment of the connection HSK; and
   a third sending module MS_TX3 configured to send at least one encrypted message ENC_MSG to the device CLT;
a receiving module MS_RX configured to receive messages from the device CLT, comprising in particular:
   a first receiving module MS_RX1 configured to receive a challenge CH from the device CLT; and
   a second receiving module MS_RX2 configured to receive at least one encrypted message ENC_MSG from the device CLT;
an encryption module MS_ENC configured to encrypt messages, comprising in particular:
   a first encryption module MS_ENC1 configured to encrypt the challenge CH by using the key KEY and the suite CIPHER;
   a second encryption module MS_ENC2 configured to encrypt at least one message MSG by using the key KEY, the suite CIPHER and, according to one embodiment, the key KEY′;
a decryption module MS_DEC configured to decrypt at least one encrypted message ENC_MSG by using the key KEY, the suite CIPHER and, according to one embodiment, the key KEY′; and
a marking module MS_MRK configured to activate the unencrypted indicator SPINBIT in messages sent to the device CLT.

The term module can correspond to both a software component and a hardware component or a set of hardware and software components, a software component itself corresponding to one or more computer programs or subprograms or more generally to any element of a program able to implement a function or a set of functions as described for the modules concerned. In the same way, a hardware component corresponds to any element of a set of hardware able to implement a function or a set of functions for the module concerned (integrated circuit, smart card, memory card, etc.).

It should be noted that the order in which the steps of a method in accordance with the invention are performed, in particular with reference to the attached drawings, constitutes only one exemplary embodiment without any limitation, variants being possible. Moreover, the reference signs are not limiting the scope of protection, their sole function being to facilitate the understanding of the claims.

1. A method for verifying usage of a cipher suite to encrypt data exchanged during a connection between a first device and a second device in a communication network, the method being implemented by a verification entity and comprising:
sending, to the first device, a challenge;
receiving, from the first or the second device, an encryption key;
receiving from the first or the second device, a challenge encrypted by the second device; and
verifying a usage of said cipher suite by using at least the sent challenge, the received encrypted challenge, the encryption key, and said cipher suite.

2. The method of claim 1, further comprising obtaining an identifier of said cipher suite in at least one message sent by the first or the second device.

3. The method of claim 2, wherein the identifier of said cipher suite is obtained in at least one message exchanged between the first and the second device during an establishment of a connection, said at least one message indicating to use said cipher suite.

4. The method of claim 1, further comprising:
obtaining at least one encrypted message exchanged between the first and the second device;
decrypting said at least one encrypted message obtained by using the encryption key and said cipher suite; and
verifying an integrity of said at least one decrypted message by using at least one message authentication code associated with said at least one decrypted message.

5. The method of claim 1, further comprising:
obtaining at least one encrypted message, exchanged between the first and the second device, comprising:
applicative data encrypted by using another encryption key distinct from said received encryption key; and
padding data encrypted by using the received encryption key, said padding data comprising the challenge sent to the first device;
decrypting said encrypted padding data by using the received encryption key and said cipher suite; and
verifying a correspondence between the challenge comprised in said decrypted padding data and the challenge sent to the first device.

6. The method of claim 3, wherein the verification entity obtains only messages exchanged between the first and the second device comprising an active unencrypted indicator.

7. The method of claim 6, wherein the unencrypted indicator is comprised in the header of the exchanged messages.

8. The method of claim 1, further comprising verifying that the identifier of said cipher suite belongs to a list of identifiers of cipher suites considered valid.

9. The method of claim 1, further comprising, upon a determination that at least one result of a said verification is negative, sending an instruction to interrupt the exchanges between the first and the second device.

10. A method for proving usage of a cipher suite to encrypt data exchanged during a connection between a first device and a second device in a communication network, the method being implemented by the first device and comprising:
receiving, from a verification entity, a challenge;
sending, to the second device, a connection initiation message comprising the challenge;
receiving, from the second device, the challenge encrypted by the second device by using an encryption key and said cipher suite; and
sending, to the verification entity, the encrypted challenge.

11. A method for proving usage of a cipher suite to encrypt data exchanged during a connection between a first device and a second device in a communication network, the method being implemented by the second device and comprising:
receiving, from the first device, a connection initiation message comprising a challenge;
encrypting the challenge by using an encryption key and said cipher suite; and
sending, to the first device or to a verification entity, the encrypted challenge.

12. The method of claim 1, wherein a TLS type protocol is used to exchange data between the first and the second device.

13. An entity (CSC) for verifying usage of a cipher suite to encrypt data exchanged during a connection between a first device and a second device in a communication network, the verification entity comprising a processor, the verification entity configured to:
send, to the first device, a challenge;
receive, from the first or the second device, an encryption key and receive, from the first or the second device, a challenge encrypted by the second device; and
verify a usage of said cipher suite by using at least the sent challenge, the received encrypted challenge, the encryption key, and said cipher suite.

14. A first communication device, comprising a processor, the first communication device configured to:
receive, from a verification entity, a challenge;
send, to the second device, a connection initiation message comprising the challenge;
receive, from the second device, the challenge encrypted by the second device by using an encryption key and a cipher suite; and
send, to the verification entity, the encrypted challenge.

15. A second communication device, comprising a processor, the second communication device configured to:
receive, from a first device, a connection initiation message comprising a challenge;
encrypt the challenge by using an encryption key and a cipher suite; and
send, to the first device or to a verification entity, the encrypted challenge.

16. A terminal comprising verification entity (CSC) of claim 13.

17. A non-transitory, computer-readable medium having stored thereon instructions which, when executed by a processor, causes the processor to perform the method of claim 1.

18. A terminal comprising the first communication device of claim 14.

19. A terminal comprising the second communication device of claim 15.
